(19) United States
(12) Patent Application Publication
(10) Pub. No.: US 2024/0245215 A1
(43) Pub. Date: Jul. 25, 2024

(54) Shelf fitting for a furniture assembley

(71) Applicant: Hafele Berlin GmbH &Co KG, Berlin (DE)

(72) Inventors: Robert Birkner, Berlin (DE); Gerd Sawatzki, Datteln (DE)

(21) Appl. No.: 18/624,509

(22) Filed: Apr. 2, 2024

Related U.S. Application Data
(63) Continuation of application No. PCT/EP22/77056, filed on Sep. 28, 2022.

(30) Foreign Application Priority Data
Oct. 6, 2021 (DE) 20 2021 105 403.4

(51) Int. Cl. A47B 96/06; F16B 12/22

(52) U.S. Cl. CPC A47B 96/066; F16B 12/22; A47B 2230/07; A47B 2230/11

(57) ABSTRACT

A fitting for connecting two parts includes a first and second fitting part. The first fitting part has a first installation body, with a slider, movably guided against a restoring force from a front starting position. At least one front slider end has an undercut protruding out of the first installation body toward the front. The second fitting part has a second installation body for mounting on a second part to be connected. The second installation body has a keyhole with an insertion opening for inserting the front slider end and with a slotted opening, which adjoins the insertion opening and which is constricted in comparison with the insertion opening, for engaging behind the undercut of the front slider end. The slider has a gear rack and a gear rotatably mounted in the first installation body and meshes with the gear rack and can be manually rotated.

### CROSS-REFERENCE TO RELATED APPLICATIONS

This continuation application claims priority to PCT/EP2022/077056 filed on Sep. 28, 2022 which has published as WO 2023/057290 A1 and also the German application number DE 20 2021 105 403.4 filed on Oct. 6, 2021, the entire contents of which are fully incorporated herein with these references.

### DESCRIPTION

### Field of the Invention

The invention relates to a fitting, in particular a shelf fitting, for connecting two parts, in particular two furniture parts, e.g. a shelf to a side wall, and an associated assembly comprising two parts which are connected to one another by means of the fitting.

### Background of the Invention

Such fittings are sufficiently well known.

Given the above, the object on which the present invention is based is that of specifying a fitting for connecting two parts which is of as simple as possible construction.

### SUMMARY OF THE INVENTION

According to the invention, this object is achieved by a fitting, in particular a shelf fitting, for connecting two parts, in particular two furniture parts, comprising: a first fitting part with a first installation body for mounting on a first part to be connected, with a slider, which is movably guided in the first installation body and can be moved rearward against the action of a restoring force from a front starting position, in which at least one front slider end having an undercut protrudes out of the first installation body toward the front, into a rear end position, in which the front slider end does not protrude out of the first installation body; and a second fitting part in the form of a second installation body for mounting on a second part to be connected, wherein the second installation body has a keyhole with an insertion opening for inserting the front slider end and with a slotted opening, which adjoins the insertion opening and which is constricted in comparison with the insertion opening, for engaging behind the undercut of the front slider end, wherein the slider has a gear rack, which extends in the sliding direction of the slider, and a gear which is rotatably mounted in the first installation body and meshes with the gear rack and can be manually rotated from the outside in order to move the slider into the rear end position against the action of the restoring force, or wherein the front side of the second installation body has, on the side of the keyhole facing away from the slotted opening, an additional opening, which opens into the insertion opening and has an oblique opening base, whose depth in relation to the front side, when viewed in the direction away from the insertion opening, decreases continuously to the level of the front side, for movement of the slider into the rear end position against the action of the restoring force.

The at least one front slider end is preferably of pin-shaped design.

The fitting according to the invention allows tool-free installation on the two parts, wherein the installed fitting is virtually invisible. By means of the gear and the gear rack, it is possible in the first variant of the invention to push the slider into the rear end position from the outside against the action of the restoring force. In the second variant of the invention, the slider can be pushed into the rear end position by way of the oblique opening base against the action of the restoring force.

The restoring force is preferably provided by a spring, in particular a compression spring, which is supported both on the first installation body and on the slider.

The slider can have one or more parallel front slider ends, each having an undercut, which interact with corresponding keyholes of the second fitting part.

As a particular preference, the slider is latched to the first installation body in the rear end position. During the disassembly of a shelf having a plurality of such fittings, it is thus possible first of all to transfer all the fittings to their rear end position and then to remove the shelf.

In the first variant of the invention, the first installation body preferably has an access opening for rotation of the gear. In the second variant of the invention, the depth of the oblique opening base at the insertion opening corresponds at least to the sum of the distance of the end face from the undercut of the front slider end and the thickness of the opening wall, defining the slotted opening, of the second installation body.

Along the slotted opening, the second fitting part can advantageously have an obliquely rearward-extending tightening contour for the undercut of the front slider end in order to pull the first and the second fitting part into mutual contact.

As a particular preference, the first installation body is formed from two housing halves, in particular of identical construction, which each have on the inside a guide recess for the slider. In this case, at least one of the two housing halves, in particular both housing halves, can have a respective bearing opening, in which the gear is rotatably mounted and is accessible from the outside for rotary actuation.

The first installation body and the second installation body preferably have external projections and/or external transverse ribs in order to anchor the installation bodies in corresponding bores in furniture parts.

The invention also relates to an assembly, in particular a furniture assembly, comprising two parts and a fitting designed as above, wherein the first fitting part is mounted on the one, first part, and the second fitting part is mounted on the other, second part, and wherein the at least one front slider end is inserted into the keyhole and engages by means of its undercut behind the slotted opening in the insertion direction. All that can be seen is a bore in the shelf for resetting the slider, after it has been moved initially out of the keyhole undercut, back into the rear end position and thus for the release of the connection.

The first fitting part is preferably mounted by means of its first installation body in a recess, in particular a slotted bore or milled feature, of the first part, and the second fitting part is mounted by means of its second installation body in a recess, in particular a slotted bore or milled feature, of the second part. The front sides of the two installation bodies each advantageously end flush with the two parts and rest against each other.

Further advantages of the invention will become apparent from the description, the claims and the drawing. The features mentioned above and those presented below can likewise be used individually or together in any desired combinations. The embodiments shown and described should not be understood as an exclusive enumeration; on the contrary they are of an illustrative character intended to describe the invention.

### BRIEF DESCRIPTION OF THE DRAWINGS

In the drawings:

FIGS. 1a, 1b show the two fitting parts of the fitting according to the invention in a perspective view (FIG. 1a) and in a view with the upper housing half of the one, first fitting part removed (FIG. 1b);

FIG. 2 shows an exploded view of the first fitting part without the upper housing half;

FIG. 3 shows a front view of the other, second fitting part;

FIGS. 4a-4c show the mode of operation of the fitting according to the invention;

FIG. 5 shows two furniture parts to be connected to one another by means of the fitting according to the invention;

FIGS. 6a-6d show the assembly steps for connecting the two furniture parts shown in FIG. 5 by means of the fitting according to the invention;

FIG. 7 shows a front view of a modified second fitting part;

FIG. 8 shows the two fitting parts of a second embodiment of the fitting according to the invention in a perspective view;

FIG. 9 shows a second embodiment of a fitting according to the invention formed from two fitting parts;

FIGS. 10a, 10b show the one, first fitting part of the second embodiment in a perspective view with the upper housing half removed (FIG. 10a) and in an exploded view (FIG. 10b);

FIGS. 11a, 11b show the other, second fitting part of the second embodiment in a longitudinal section (FIG. 11a) and in a front view (FIG. 11b);

FIGS. 12a-12e show the mode of operation of the fitting of the second embodiment according to the invention, in each case in a longitudinal section; and

FIGS. 13a-13e show the assembly steps for connecting two furniture parts by means of the fitting of the second embodiment according to the invention.

### DETAILED DESCRIPTION OF EMBODIMENTS OF THE INVENTION

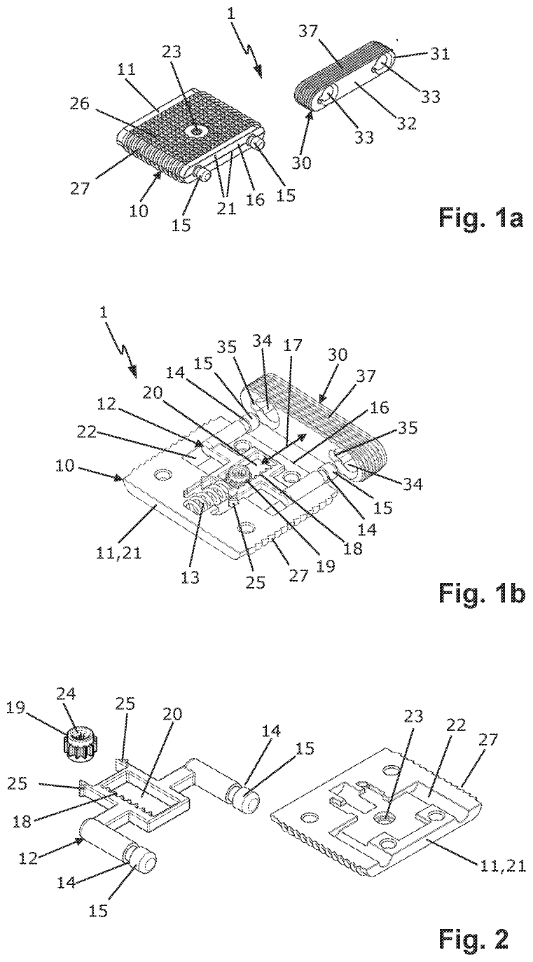

The (shelf) fitting 1 shown in FIGS. 1a, 1b is used to connect two furniture parts, in this case a shelf 2, to a side wall 3 (FIG. 5), and comprises two fitting parts 10, 30.

As FIG. 2 shows, the first fitting part 10 has a first installation body (shelf housing) 11, a slider 12, which is guided in such a way as to be movable in a straight line therein, and a compression spring 13 (FIG. 1b), which is supported at one end on the first installation body 11 and at the other end on the slider 12. The slider 12 can be moved rearward against the action of the compression spring 13 from a front starting position shown in FIGS. 1a, 1b, in which two, in this case pin-shaped, front slider ends 15, each having an undercut 14, protrude out of the installation body 11 toward the front, into a rear end position, in which the front slider ends 15 no longer protrude out of the installation body 11 but end flush with a front side 16 of the first installation body 11. The undercut 14 can be an offset in the front slider end 15 and, as shown, can be formed by an annular groove, for example.

The slider 12 has a gear rack 18, which extends in its sliding direction 17 and with which a gear 19 rotatably mounted in the first installation body 11 meshes. The gear 19 can be manually rotated from the outside in order to move the slider 12 into the rear end position against the action of the compression spring 13. As also shown in the exemplary embodiment, the gear 19 can, for example, be arranged in a rectangular opening 20 of the slider 12, one side wall of which opening is designed as a gear rack 18 and the opposite, smooth side wall of which rests against the gear 19 and can slide thereon. Alternatively, the opposite side wall may also not rest against the gear 19 and thus not slide thereon; in this case, the slider 12 may also be arranged in an opening which is not rectangular.

The first installation body 11 is preferably assembled from two housing halves 21 of identical construction, each having inner guide recesses 22 for the slider 12, which is arranged between them. The two housing halves 21 each have an internally and externally open bearing or access opening 23, in which the gear 19 is rotatably mounted and through which a tool can be inserted from the outside in order to engage in a slot 24, in this case a cross-shaped slot, or alternatively in a hexagon socket or Torx socket of the gear 19. The slider 12 is guided movably in the guide recesses 22, wherein two lateral latching projections 25 on the rear slider end prevent the slider 12 from being pushed out of the first installation body 11 (in this position, the front slider ends 15 are set back in the first installation body 11). The upper and lower sides of the first installation body 11, which are shown in FIG. 1a can optionally be structured with pointed, in this case pyramidal, projections 26 (or transverse ribs), and the two narrow sides of the first installation body 11 can have external transverse ribs 27.

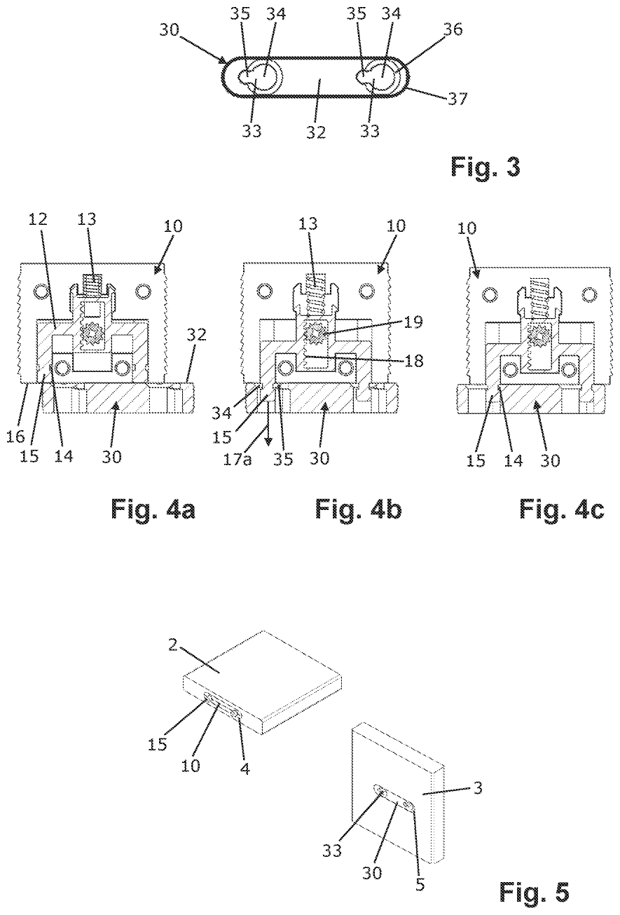

The second fitting part 30 is a second installation body (sleeve) 31 with a front side 32 which has two keyholes 33 spaced apart in the direction of the width of the front side 32. As shown in FIG. 3, these keyholes 33 each have an insertion opening 34, in this case a round insertion opening, for inserting the front slider end 15, and a slotted opening 35, which adjoins the insertion opening 34 in the direction of the width, in this case on the left, and which is constricted in comparison with the insertion opening 34, for engaging behind the undercut 14 of the front slider end 15. A chamfer 36 on the insertion opening 34 makes it easier to insert the front slider end 15. The second installation body 31 optionally has external transverse ribs 37.

FIGS. 4a-4c show the mode of operation of the shelf fitting 1.

In FIG. 4a, the front sides 16, 32 of the two fitting parts 10, 30 rest against one another, as a result of which the front slider ends 15 are pushed back into their rear position by the front side 32 against the action of the compression spring 13.

In FIG. 4b, the first fitting part 10 has been moved transversely to the right relative to the second fitting part 30 until the front slider ends 15, driven by the compression spring 13, have entered the insertion openings 34 in insertion direction 17a. During this process, the gear 19 is rotated counterclockwise by the gear rack 18.

In FIG. 4c, the first fitting part 10 has been moved transversely even further to the right relative to the second fitting part 30 until the undercuts 14 of the inserted front slider ends 15 have each entered the slotted opening 35 and engage behind the slotted opening 35 in insertion direction 17a. As a result, the first fitting part 10 is locked on the second fitting part 30 counter to the insertion direction 17a.

As shown in FIG. 5, the first fitting part 10 is mounted by means of its first installation body 11 in a horizontal end recess (e.g. slotted bore or milled feature) 4 of the shelf 2, and the second fitting part 30 is mounted by means of its second installation body 31 in a horizontal recess (e.g. slotted bore or milled feature) 5 of the side wall 3. In this case, the front side 16 of the first installation body 11 preferably ends flush with the shelf 2, and the front side 32 of the second installation body 21 ends flush with the side wall 3.

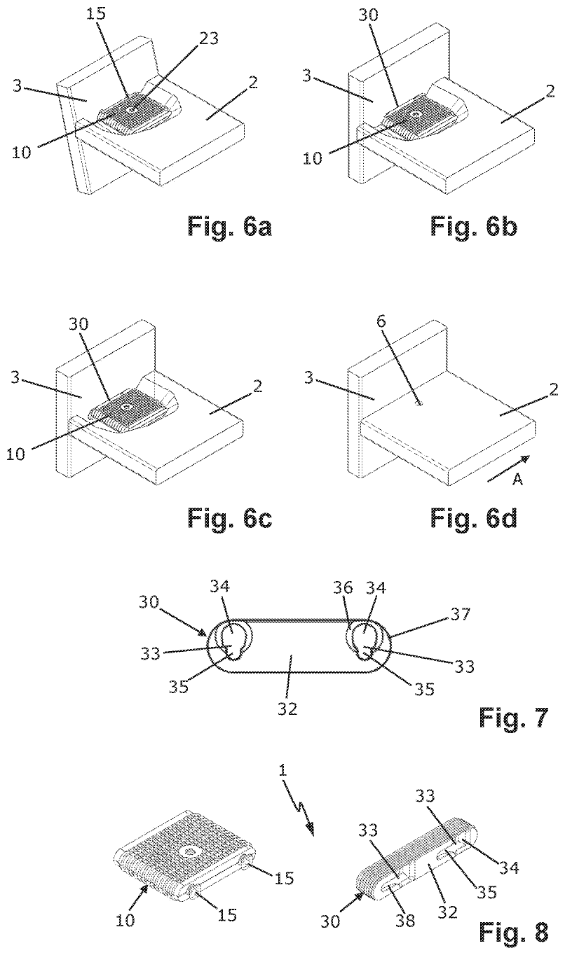

FIGS. 6a-6d show the individual assembly steps for connecting the shelf 2 to the side wall 3 by means of the shelf fitting 1.

The shelf 2 is first of all inserted in a tilted orientation between two vertical side walls 3 (FIG. 6a), and is then aligned in the horizontal position, as a result of which the front slider ends 15 are pushed back into their rear position by the side wall 3 against the action of the compression spring 13 (FIG. 6b). The shelf 2 is moved transversely in the vertical and the depth direction until the front slider ends 15, driven by the compression spring 13, enter the insertion openings 34 (FIG. 6c). The shelf 2 is pushed further rearward relative to the side wall 3 (arrow direction A) until the undercuts 14 of the front slider ends 15 have each entered the slotted opening 35 and engage behind the slotted opening 35 in insertion direction 17a (FIG. 6d). An obliquely rearward-extending tightening contour 38 (FIG. 8) on the front side 32 has the effect that the front slider ends 15 and thus also the first fitting part 10 is pulled into contact with the second fitting part 30. A constriction (not shown) in the slotted opening 35 ensures perceptible feedback when the end position is reached, and ensures end position fixing.

The shelf fitting 1 allows assembly without tools, wherein the installed shelf fitting 1 is virtually invisible. Only a bore 6 in the shelf 2 for releasing the connection can be seen.

The disassembly process takes place correspondingly in reverse with respect to the assembly process described. The shelf 2 is pulled forward until the front slider ends 15 are once again situated in the insertion openings 34. A tool, e.g. a screwdriver, is inserted through the opening 6 in the shelf 2 and through the access opening 23 in the first fitting part 10, and the gear 19 is rotated clockwise in the view in FIGS. 4a-4c. As a result, the slider 12 is pushed backward into a rear position and is latched there to the first installation body 11 by means of the latching projections 25. This process is repeated for all the shelf fittings 1 present, after which the shelf 2 can be removed.

The second fitting part 30, which is shown in FIG. 7, differs from FIG. 3 only in that, here, the slotted opening 35 adjoins the insertion opening 34 in the vertical direction, in this case toward the top. During assembly, the shelf 2 is moved transversely downward in order to lock the first fitting part 10 to the second fitting part 30.

The shelf fitting 1 shown in FIG. 8 differs from FIG. 1 only in that, here, the front slider ends 15 have a rectangular or square outer contour. Alternatively, some other polygonal or oval (elliptical) outer contour is also possible. The opening contour of the insertion opening 34 is correspondingly adapted to the outer contour of the front slider ends 15.

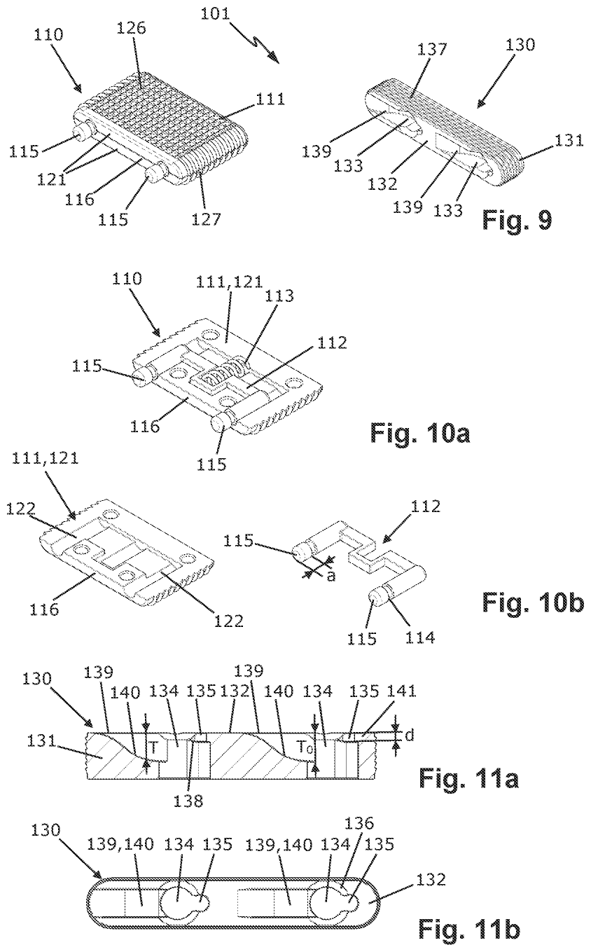

The shelf fitting 101 shown in FIGS. 9-11 differs from the shelf fitting 1 in FIGS. 1-3 in that, in the case of the first fitting part 110, the first installation body 111 does not have a gear or an access opening, and the slider 112 does not have a gear rack, and in that, in the case of the second fitting part 130, the front side 132 of the second installation body 131 in each case has an additional opening 139, which opens into the insertion opening 134 on the side of the keyhole 133 facing away from the slotted opening 135. The additional opening 139 has an oblique opening base 140, whose depth T in relation to the front side 132, when viewed in the direction away from the insertion opening 134, decreases continuously to the level of the front side 132. The depth T₀ at the insertion opening 134 corresponds at least to an entry depth of the front slider end 115, which is defined by the sum of the distance a of the end face from the undercut 114 of the front slider end 115 and the thickness d of the opening wall 141, defining the slotted opening 135, of the second installation body 131, i.e. T₀≥a+d.

Along the slotted opening 135, the second fitting part 130 optionally has an obliquely rearward-extending tightening contour 138 for the undercut 114 of the front slider end 115 in order to pull the first and the second fitting part 110, 130 into mutual contact. The first installation body 111 can optionally be formed by two housing halves 121, in particular of identical construction, which each have on the inside a guide recess 122 for the slider 112. As a further option, the first installation body 111 can have external projections 126 and external transverse ribs 127, and the second installation body 131 can have external transverse ribs 137.

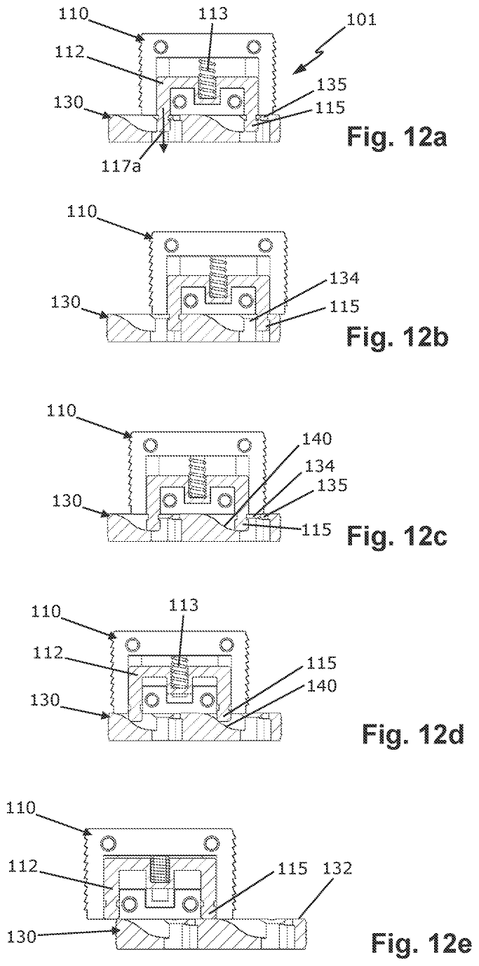

FIGS. 12a-12e show the mode of operation of the shelf fitting 101.

In FIG. 12a, the two fitting parts 110, 130 rest against one another by means of their front sides 116, 132, and the first fitting part 110 has been moved transversely relative to the second fitting part 130 until the front slider ends 115, driven by the compression spring 113, have entered the insertion openings 134 in insertion direction 117a.

In FIG. 12b, the first fitting part 110 has been moved transversely to the right relative to the second fitting part 130 until the undercuts 114 of the inserted front slider ends 115 have each entered the slotted opening 135 and engage behind the opening wall 141 in insertion direction 117a. As a result, the first fitting part 110 is locked on the second fitting part 130 counter to the insertion direction 117a.

For disassembly, the first fitting part 110 is moved transversely to the left relative to the second fitting part 130 until the front slider ends 115 have emerged from the slotted opening 135 and have been pushed beyond the insertion openings 134 and meet the oblique opening base 140 (FIG. 12c).

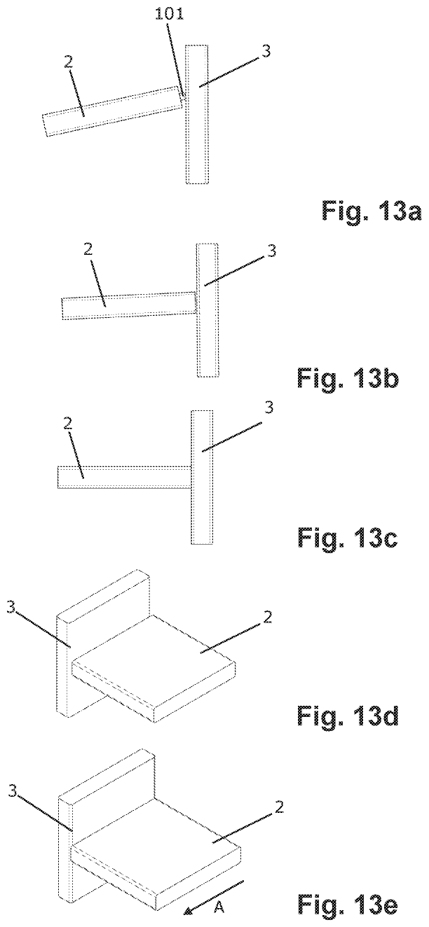

When the first fitting part 110 is moved further transversely to the left, the front slider ends 115 are then pushed back on the oblique opening base 140—as is therefore also the slider 112—against the force of the compression spring 113 (FIG. 12d) until, finally, they rest against the front side 132 in the rear slider position (FIG. 12e). FIGS. 13a-13e show the individual assembly steps for connecting the shelf 2 to the side wall 3 by means of the shelf fitting 101.

The shelf 2 is first of all inserted in a tilted orientation between two vertical side walls 3 (FIG. 13a), and is then aligned in the horizontal position, as a result of which the front slider ends 115 are pushed back into their rear position by the side wall 3 against the action of the compression spring 113 (FIG. 13b). The shelf 2 is moved transversely in the vertical and the depth direction until the front slider ends 115, driven by the compression spring 113, enter the insertion openings 134 (FIGS. 13c, 13d). The shelf 2 is pushed further rearward relative to the side wall 3 (arrow direction A) until the undercuts 114 of the front slider ends 115 have each entered the slotted opening 135 and engage behind the opening wall 141 in insertion direction 117a (FIG. 13e). The shelf fitting 101 allows assembly and disassembly without tools, wherein the installed shelf fitting 101 is invisible.

What is claimed is:

1. A fitting configured for connecting two parts, comprising:
a first fitting part with a first installation body configured for mounting on a first part to be connected, and with a slider, which is movably guided in the first installation body and can be moved rearward against the action of a restoring force from a front starting position, in which at least one front slider end having an undercut protrudes out of the first installation body toward the front, into a rear end position, in which the front slider end does not protrude out of the first installation body; and
a second fitting part in the form of a second installation body configured for mounting on a second part to be connected, wherein the second installation body has a keyhole with an insertion opening configured for inserting the front slider end and with a slotted opening, which adjoins the insertion opening and which is constricted in comparison with the insertion opening, configured for engaging behind the undercut of the front slider end;
wherein the slider has a gear rack, which extends in the sliding direction of the slider, and a gear, which is rotatably mounted in the first installation body and meshes with the gear rack and can be manually rotated from the outside in order to move the slider into the rear end position against the action of the restoring force, or wherein the front side of the second installation body has, on the side of the keyhole facing away from the slotted opening, an additional opening, which opens into the insertion opening and has an oblique opening base, whose depth in relation to the front side, when viewed in the direction away from the insertion opening, decreases continuously to the level of the front side, configured for movement of the slider into the rear end position against the action of the restoring force.

2. The fitting as claimed in claim 1, wherein the gear is arranged in an opening of the slider, one side wall of which opening has the gear rack.

3. The fitting as claimed in claim 1, wherein the first installation body has an access opening configured for rotation of the gear.

4. The fitting as claimed in claim 1, wherein the depth of the oblique opening base at the insertion opening corresponds at least to the sum of the distance of the end face from the undercut of the front slider end and the thickness of the opening wall, defining the slotted opening, of the second installation body.

5. The fitting as claimed in claim 1, wherein the restoring force is provided by a spring, which is supported both on the first installation body and on the slider.

6. The fitting as claimed in claim 1, wherein the at least one front slider end is of pin-shaped design.

7. The fitting as claimed in claim 1, wherein the slider has at least two parallel front slider ends, each having an undercut.

8. The fitting as claimed in claim 1, wherein the slider is latched to the first installation body in the rear end position.

9. The fitting as claimed in claim 1, wherein the second fitting part has, along the slotted opening, an obliquely rearward-extending tightening contour configured for the undercut of the front slider end in order to pull the first and the second fitting part into mutual contact.

10. The fitting as claimed in claim 1, wherein the first installation body is formed from two housing halves, which each have on the inside a guide recess configured for the slider.

11. The fitting as claimed in claim 10, wherein at least one of the two housing halves has a respective bearing opening in which the gear is rotatably mounted.

12. The fitting as claimed in claim 1, wherein the first installation body has external projections and/or external transverse ribs.

13. The fitting as claimed in claim 1, wherein the second installation body has external transverse ribs.

14. An assembly comprising the two parts and the fitting as claimed in claim 1, wherein the first fitting part is mounted on the one, first part, and the second fitting part is mounted on the other, second part, and wherein the at least one front slider end is inserted into the keyhole and engages by means of its undercut behind the slotted opening in the insertion direction.

15. The assembly as claimed in claim 14, wherein the first fitting part engages by means of its first installation body in a recess of the first part, and the second fitting part is mounted by means of its second installation body in a recess of the second part.

16. The assembly as claimed in claim 14, wherein the front side of the first installation body ends flush with the first part, and the front side of the second installation body ends flush with the second part.

17. The assembly as claimed in claim 14, wherein the front side of the first installation body and the front side of the second installation body rest against one another.
